(19) United States
(12) Patent Application Publication
(10) Pub. No.: US 2019/0131619 A1
(43) Pub. Date: May 2, 2019

(54) NEGATIVE ELECTRODE FOR LITHIUM METAL SECONDARY BATTERY AND LITHIUM METAL SECONDARY BATTERY INCLUDING THE SAME

(71) Applicants: Hyundai Motor Company, Seoul (KR); Kia Motors Corporation, Seoul (KR)

(72) Inventors: Jong Chan Song, Suwon-si (KR); Byung Gon Kim, Suwon-si (KR); Sam Ick Son, Suwon-si (KR)

(73) Assignees: Hyundai Motor Company, Seoul (KR); Kia Motors Corporation, Seoul (KR)

(21) Appl. No.: 15/829,658

(22) Filed: Dec. 1, 2017

(30) Foreign Application Priority Data
Oct. 26, 2017 (KR) 10-2017-0140228

(51) Int. Cl. H01M 4/36; H01M 4/134; H01M 4/133; H01M 4/38; H01M 4/587; H01M 10/0525; H01M 4/04

(52) U.S. Cl. CPC H01M 4/366; H01M 4/134; H01M 4/133; H01M 2004/027; H01M 4/587; H01M 10/0525; H01M 4/045; H01M 4/382

(57) ABSTRACT

Provided herein is a negative electrode for a lithium metal secondary battery comprising a first electrode layer comprising lithium and a second electrode layer provided on the first electrode layer and comprising amorphous carbon. The second electrode layer may have a specific surface area of from about 1 m²/g to about 300 m²/g.

### CROSS-REFERENCE TO RELATED APPLICATION

The present application claims priority to Korean Patent Application No. 10-2017-0140228, filed Oct. 26, 2017, the entire contents of which is incorporated herein for all purposes by this reference.

### BACKGROUND OF THE INVENTION

### Field of the Invention

The present invention relates to a negative electrode for a lithium metal secondary battery and a lithium metal secondary battery including the same.

### Description of Related art

A lithium metal secondary battery has attracted attention as a next-generation secondary battery for an electric vehicle battery because of its high energy density. In the lithium metal secondary battery, the high energy density (capacity per weight) is expressed by applying a carbon material having a light weight and high conductivity to a positive electrode. However, there is a problem in that a resistant material is formed during charging/discharging of the battery, an uneven structure change occurs in the electrode, and the safety and lifespan of the battery are not maintained for a long time. In order to solve this problem, various methods such as the use of a protective film, an electrolyte composition and an additive, and reformation of a separator have been provided. However, there is no complete solution yet.

It has been reported that when the concentration of lithium salt in an electrolyte is increased from 1M to 4M to 5M side reactions between a reactive solvent and lithium are decreased, lithium electrodeposition becomes uniform during charging, and the lifespan of the cell can be improved. However, when a salt electrolyte is used at a high concentration, the electrolyte price may increase according to an increase in the used amount of the lithium salt. In addition, a decrease in ion conductivity and wettability of the separator may occur due to an increase in the viscosity of the electrolyte. Also, the resistance may be largely increased at the time of driving the cell due to limited oxygen solubility (in case of lithium-oxygen battery) and a decrease in diffusion. Even if an electrolyte containing a high concentration of lithium salt is not used, carbon which may exhibit a similar effect thereto is disposed on the electrode surface to achieve improvement of uniformity of electrodeposition through lithium ion adsorption and reduction in occurrence of side reactions.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a negative electrode for a lithium metal secondary battery capable of contributing to increasing a charge capacity and a discharge capacity and improving the lifespan of the lithium metal secondary battery.

Various aspects of the present invention are directed to providing a lithium metal secondary battery capable of contributing to increasing a charge capacity and a discharge capacity and improving the lifespan of the lithium metal secondary battery.

Various aspects of the present invention are directed to providing a negative electrode for a lithium metal secondary battery comprising a first electrode layer comprising lithium and a second electrode layer provided on the first electrode layer and comprising amorphous carbon. The second electrode layer may have a specific surface area of from about 1 m²/g to about 300 m²/g.

In various exemplary embodiments, the second electrode layer may comprise a plurality of pores.

In various exemplary embodiments, the second electrode layer may be a carbon paper or a carbon sheet.

In various exemplary embodiments, the second electrode layer may have a value of G band peak intensity/D band peak intensity of from about 0.1 to about 1.0 in the Raman analysis.

In other exemplary embodiments, the resistance of the second electrode layer may be from about 10 mΩcm²to about 25 mΩcm².

In various exemplary embodiments, the second electrode layer may have a porosity of from about 30% to about 50%.

Various aspects of the present invention are directed to providing a lithium metal secondary battery comprising a positive electrode, a negative electrode facing the positive electrode, and an electrolyte provided between the positive electrode and the negative electrode. The negative electrode may comprise a first electrode layer comprising lithium and a second electrode layer provided on the first electrode layer and comprising amorphous carbon. The second electrode layer may have a specific surface area of from about 1 300 m²/g to about 300 m²/g.

In an exemplary embodiment of the present invention, when the lithium metal secondary battery is charged and discharged, the second electrode layer may have a charge amount of 60 to 80 μAh/cm².

In various exemplary embodiments, when the lithium metal secondary battery is charged and discharged, a plurality of lithium may be adsorbed on the inside of the second electrode layer and the surface of the second electrode layer.

According to the exemplary embodiment of the present invention, it is possible to provide a negative electrode for a lithium metal secondary battery with high charge and discharge capacities and improved lifespan.

According to the exemplary embodiment of the present invention, it is possible to provide a lithium metal secondary battery with high charge and discharge capacities and improved lifespan.

Other aspects and exemplary embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of a negative electrode for a lithium metal secondary battery according to an exemplary embodiment of the present invention;

FIG. 2A is a cross-sectional view illustrating lithium metal is electrodeposited on a second electrode layer;

FIG. 2B is a plan view illustrating lithium metal is electrodeposited on the second electrode layer;

FIG. 3A is an SEM photograph of lithium metal electrodeposited on a second electrode layer in Example 1 and FIG. 3B is an SEM photograph of lithium ions when there is no second electrode layer in Comparative Example 1;

FIG. 4A and FIG. 4B are graphs illustrating a relationship between a capacity and a voltage after lithium metal secondary batteries in Example 1 and Comparative Example 1 are charged and discharged 10 times;

FIG. 5 is a graph illustrating a relationship between a capacity and a voltage in Example 1 and Comparative Example 1; and

FIG. 6 is a graph illustrating a capacity when charging/discharging is repeatedly performed in Example 1 and Comparative Example 1.

Reference numerals set forth in the Drawings includes reference to the following elements as further discussed below:

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The above objects, other objects, features, and advantages of the present invention will be easily understood through the following exemplary embodiments with reference to the accompanying drawings. The present invention is not limited to the embodiments described therein and may also be implemented in various different ways. On the contrary, embodiments introduced herein are provided to make disclosed contents thorough and complete and sufficiently transfer the spirit of the present invention to those skilled in the art.

In the description of each drawing, like reference numerals are used for like constitute elements. In the accompanying drawings, dimensions of structures are illustrated to be more enlarged than actual dimensions for clarity of the present invention. Terms such as first, second, and the like may be used to describe various components and the components should not be limited by the terms. The terms are used to only distinguish one component from another component. For example, a first component may be referred to as a second component, and similarly, the second component may be referred to as the first component without departing from the scope of the present invention. Singular expressions used herein include plural expressions unless they have definitely opposite meanings in this context.

In the present application, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance. It will be understood that when an element such as a layer, film, region, or substrate is referred to as being “on” another element, it can be “directly on” the other element or intervening elements may also be present. On the contrary, it will be understood that when an element such as a layer, film, region, or substrate is referred to as being “below” another element, it can be “directly below” the other element or intervening elements may also be present.

A lithium metal secondary battery according to an exemplary embodiment of the present invention comprises a positive electrode, a negative electrode, and an electrolyte.

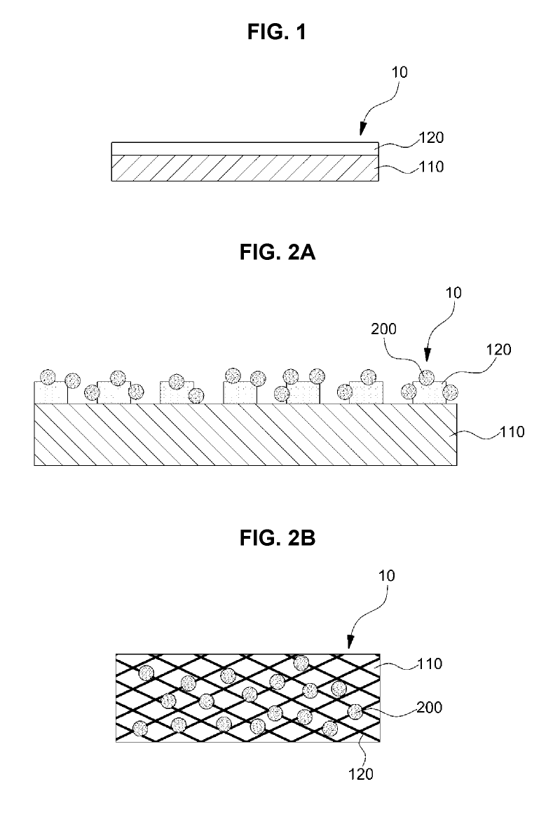

FIG. 1 is a cross-sectional view of a negative electrode for a lithium metal secondary battery according to an exemplary embodiment of the present invention.

Referring to FIG. 1, a negative electrode 10 for the lithium metal secondary battery according to an exemplary embodiment of the present invention includes a first electrode layer 110 and a second electrode layer 120. The first electrode layer 110 contains lithium. The second electrode layer 120 is provided on the first electrode layer 110. The second electrode layer 120 contains amorphous carbon. The amorphous carbon is a movement path of electrons. The amorphous carbon may be, for example, hard carbon or graphene. The second electrode layer 120 includes a plurality of pores. The second electrode layer 120 may be, for example, a carbon paper or a carbon sheet.

The second electrode layer 120 may have a specific surface area ranging from about 1 m²/g to about 300 m²/g (e.g., about 1 m²/g, about 2 m²/g, about 3 m²/g, about 4 m²/g, about 5 m²/g, about 6 m²/g, about 7 m²/g, about 8 m²/g, about 9 m²/g, about 10 m²/g, about 10 m²/g, about 15 m²/g, about 20 m²/g, about 25 m²/g, about 30 m²/g, about 35 m²/g, about 40 m²/g, about 45 m²/g, about 50 m²/g, about 55 m²/g, about 60 m²/g, about 65 m²/g, about 70 m²/g, about 75 m²/g, about 80 m²/g, about 85 m²/g, about 90 m²/g, about 95 m²/g, about 100 m²/g, about 105 m²/g, about 110 m²/g, about 115 m²/g, about 120 m²/g, about 125 m²/g, about 130 m²/g, about 135 m²/g, about 140 m²/g, about 145 m²/g, about 150 m²/g, about 155 m²/g, about 160 m²/g, about 165 m²/g, about 170 m²/g, about 175 m²/g, about 180 m²/g, about 185 m²/g, about 190 m²/g, about 195 m²/g, about 200 m²/g, about 205 m²/g, about 210 m²/g, about 215 m²/g, about 220 m²/g, about 225 m²/g, about 230 m²/g, about 235 m²/g, about 240 m²/g, about 245 m²/g, about 250 m²/g, about 255 m²/g, about 260 m²/g, about 265 m²/g, about 270 m²/g, about 275 m²/g, about 280 m²/g, about 285 m²/g, about 290 m²/g, about 295 m²/g, or about 200 m²/g. When the specific surface area of the second electrode layer 120 is less than 1 m²/g, the movement path of electrons is not sufficiently secured, and when the specific surface area of the second electrode layer 120 is more than 300 m²/g, degradation of the electrolyte excessively occurs on the amorphous carbon surface to increase a resistive material, and as a result, the porosity of the second electrode layer 120 is decreased to cause an increase in overvoltage, thereby reducing the charge/discharge capacity of the battery.

The second electrode layer 120 may have a porosity ranging from about 30% to about 50% (e.g., about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, or about 50%). When the porosity of the second electrode layer 120 is more than 50%,the movement path of electrons may not be sufficiently secured. As such, when the movement path of electrons is not sufficiently secured, the charge/discharge capacity of the battery may be reduced.

When the lithium metal secondary battery is charged and discharged, the second electrode layer 120 may have a charge amount ranging from about 60 μAh/cm²to about 80 μAh/cm² (e.g., about 60 μAh/cm², about 61 μAh/cm², about 62 μAh/cm², about 63 μAh/cm², about 64 μAh/cm², about 65 μAh/cm², about 66 μAh/cm², about 67 μAh/cm², about 68 μAh/cm², about 69 μAh/cm², about 70 μAh/cm², about 71 μAh/cm², about 72 μAh/cm², about 73 μAh/cm², about 74 μAh/cm², about 75 μAh/cm², about 76 μAh/cm², about 77 μAh/cm², about 78 μAh/cm², about 79 μAh/cm², or about 70 μAh/cm²). When the charge amount of the second electrode layer 120 is less than 60 μAh/cm², the charge/discharge capacity of the lithium metal secondary battery is not sufficient, and when the charge amount of the second electrode layer 120 is more than 80 μAh/cm², the lifespan according to charge and discharge may be lowered.

The second electrode layer 120 may have a value of G band peak intensity/D band peak intensity ranging from about 0.1 to about 1.0 (e.g., about 0.1, about 0.2, about 0.3, about 0.4, about 0.5, about 0.6, about 0.7, about 0.8, about 0.9, or about 1.0) in the Raman analysis. The G band may refer to peaks around 1,600 cm⁻¹ and the D band may refer to peaks around 1,350 cm⁻¹. The G band peak intensity/D band peak intensity may mean a carbon defect ratio I_{D}/I_{G}. When the value of G band peak intensity/D band peak intensity is less than 0.1, lithium ions are excessively electrodeposited on the second electrode layer 120 during charging and the surface area of lithium may not be uniform. When the value of G band peak intensity/D band peak intensity is more than 1.0, lithium ions are not sufficiently electrodeposited on the second electrode layer 120 during charging.

The resistance of the second electrode layer 120 may be from about 10 mΩcm²to about 25 mΩcm² (e.g., about 10 mΩcm², about 11 mΩcm², about 12 mΩcm², about 13 mΩcm², about 14 mΩcm², about 15 mΩcm², about 16 mΩcm², about 17 mΩcm², about 18 mΩcm², about 19 mΩcm², about 20 mΩcm², about 21 mΩcm², about 22 mΩcm², about 23 mΩcm², about 24 mΩcm², or about 25 mΩcm²). When the resistance of the second electrode layer 120 is less than 10 mΩcm², lithium ions may not sufficiently contained in the second electrode layer 120 during charging, and when the resistance of the second electrode layer 120 is more than 25 mΩcm², lithium may not be precipitated in the second electrode layer 120 during charging.

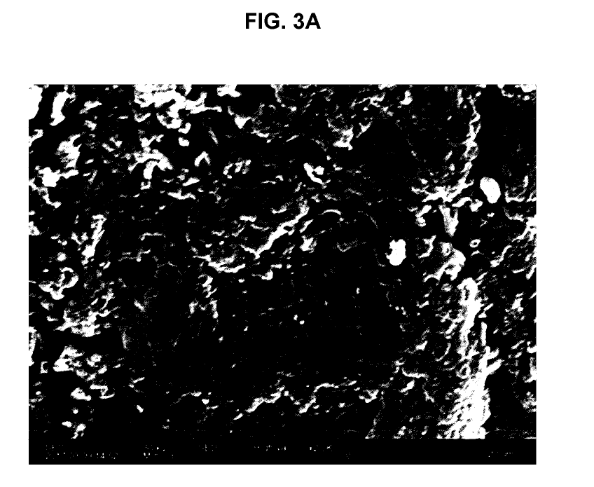

FIG. 2A is a cross-sectional view illustrating lithium metal is electrodeposited on the second electrode layer. FIG. 2B is a plan view illustrating lithium metal is electrodeposited on the second electrode layer.

Referring to FIGS. 1, 2A, and 2B, lithium ions 200 are electrodeposited on the second electrode layer 120 during charging and discharging. The lithium ions 200 are uniformly electrodeposited on the second electrode layer 120, thereby decreasing side reactions between the electrolyte 20 and the lithium ions 200. Accordingly, the present invention may provide a battery capable of maintaining a charge/discharge capacity even by repeating charge and discharge, and provide a usable negative electrode 10 for a lithium metal secondary battery. The present invention may be verified in more detail in Example 1 and Comparative Example 1 to be described below.

The negative electrode for the lithium metal secondary battery according to the exemplary embodiment of the present invention can increase the surface area of lithium electrodeposited on the second electrode layer when the lithium metal secondary battery is charged resulting in the reduction of effective current density. Moreover, lithium ions can be electrochemically adsorbed on the second electrode layer 120 prior to the lithium metal deposition at the initial stage of the charge. Such concentration of the positively charges on the surface prevents the direct contact of electrolyte thus, diminishing the electrolyte decomposition. It is very similar effect with the highly concentrated salt strategies in the view point of the charge concentration. Those combined effects lead the lithium metal secondary battery with a high efficiency and a long lifespan without using a high concentration of lithium salt as an electrolyte.

Hereinafter, the present invention will be described in more detail through detailed Examples. The following Examples are just exemplified for helping in understanding the present invention and the scope of the present invention is not limited thereto.

### EXAMPLES

### Example 1

Lithium foil with a thickness of 20 μm was prepared to form a first electrode layer. A carbon paper with a thickness of 120 μm was bonded onto the first electrode layer to form a negative electrode. A positive electrode was formed as LiNi_{0.6}Mn_{0.2}Co_{0.2}O₂, and 1 M of LiPF₆ and an electrolyte having ethylene carbonate (EC)/ethyl methyl carbonate (EMC)/dimethyl carbonate (DMC) (at a volume ratio of 2:2:1) as a solvent, polyethylene having a thickness of 25 μm as a separator were used to fabricate a lithium metal secondary battery.

### Comparative Example 1

Except for forming a negative electrode only by a first electrode layer, a lithium metal secondary battery was fabricated in the same manner as Example 1.

Evaluation of Charging/Discharging

In a potential range of 3.0 to 4.2 V, after charging/discharging was performed two times at 0.35 mA/cm², evaluation of charging/discharging was performed at 0.65 mA/cm².

Experimental Result

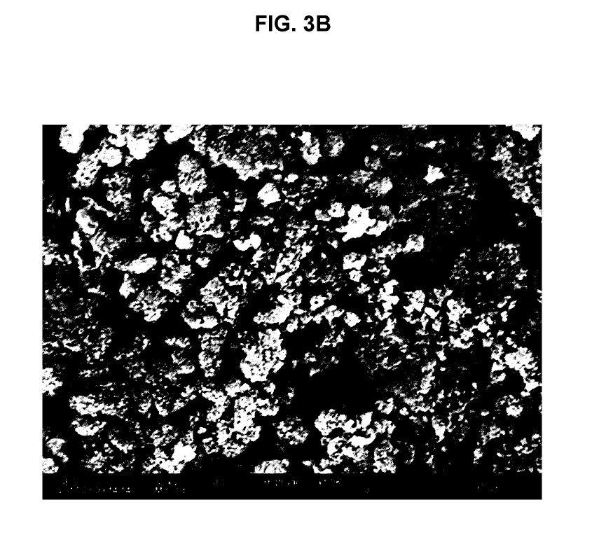

Lithium ions which were electrodeposited during charging/discharging were taken with an SEM photograph. Referring to FIG. 3A and FIG. 3B, it can be seen that in Comparative Example 1, the surface of the layer formed by electrodepositing the lithium metal is not uniform, but in Example 1, the surface of the layer formed by electrodepositing the lithium ions is uniform.

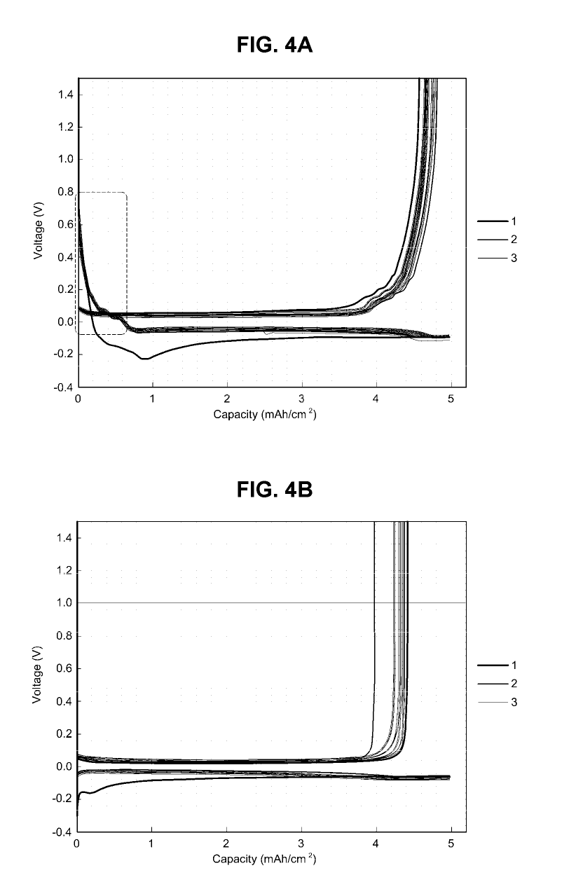

FIG. 4A and FIG. 4B are graphs illustrating a relationship between a capacity and a voltage after lithium plating and stripping 10 cycles of the anode 10 with or without second electrode layer 120 respectively. Referring to FIG. 4A, it can be seen that a capacitive effect due to the adsorption of lithium ions occurs through a slope of a marked portion. However, in FIG. 4B, such a slope does not occur. The negative electrode with second electrode layer 120 had an average charge/discharge efficiency of 94.9% per 10 times, whereas the negative electrode without electrode layer 120 had an average charge/discharge efficiency of 86.5% per 10 times.

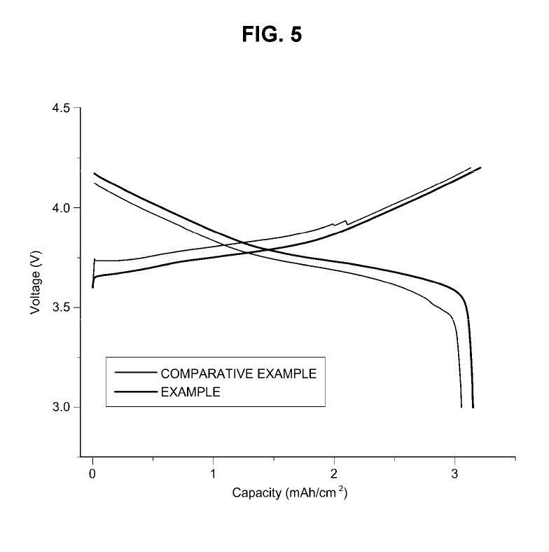

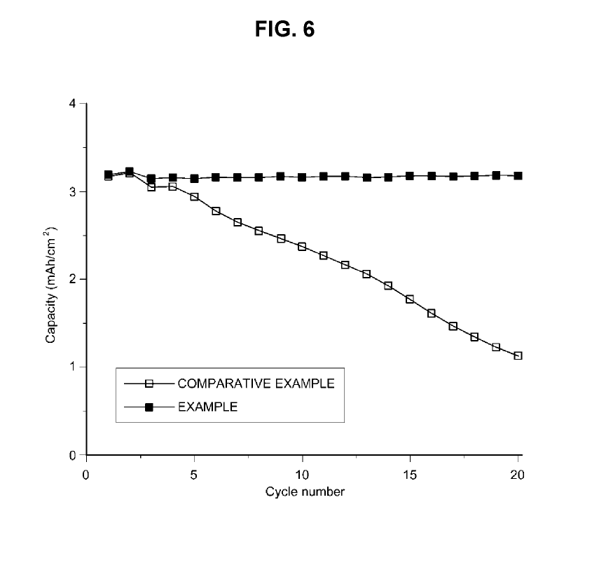

Referring to FIG. 5, it can be seen that Example 1 has a lower overpotential than Comparative Example 1 during charging and discharging, and as a result, it can be seen that lithium ions are uniformly electrodeposited on the second electrode layer and the negative electrode is stabilized. Furthermore, referring to FIG. 6, it can be seen that unlike Comparative Example 1, in Example 1, even though charging and discharging are repeated, the capacity of the battery is not decreased.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present invention, as well as various alternatives and modifications thereof It is intended that the scope of the invention be defined by the Claims appended hereto and their equivalents.

1. A negative electrode for a lithium metal secondary battery comprising:
a first electrode layer containing lithium; and
a second electrode layer provided on the first electrode layer and comprising amorphous carbon,
wherein the second electrode layer has a specific surface area of from about 1 m²/g to about 300 m²/g,
wherein the second electrode layer has a value of G band peak intensity/D band peak intensity of from about 0.1 to about 1.0 in the Raman analysis.

2. The negative electrode of claim 1, wherein the second electrode layer comprises a plurality of pores.

3. The negative electrode of claim 1, wherein the second electrode layer is a carbon paper or a carbon sheet.

4. (canceled)

5. The negative electrode of claim 1, wherein the second electrode layer has a porosity of from about 30% to about 50%.

6. A lithium metal secondary battery comprising:
a positive electrode;
a negative electrode of claim 1 facing the positive electrode; and
an electrolyte provided between the positive electrode and the negative electrode.

7. The lithium metal secondary battery of claim 6, wherein when the lithium metal secondary battery is charged and discharged, a plurality of lithium is adsorbed on the inside of the second electrode layer and the surface of the second electrode layer.
